(19) United States
(12) Patent Application Publication
(10) Pub. No.: US 2022/0060977 A1
(43) Pub. Date: Feb. 24, 2022

(54) System and Methods for Improving Audio Quality in a Wireless Device With Multi-Active Voice Configuration

(71) Applicant: QUALCOMM Incorporated, San Diego, CA (US)

(72) Inventors: Anandbabu MUSUATHY SADASIVAN, San Diego, CA (US); Shankar Ganesh LAKSHMANASWAMY, Bangalore (IN); Vikram SINGH, San Diego, CA (US)

(21) Appl. No.: 16/998,737

(22) Filed: Aug. 20, 2020

(51) Int. Cl. H04W 48/18; H04W 76/15; H04W 72/08; H04W 48/12

(52) U.S. Cl. CPC H04W 48/18; H04W 48/12; H04W 72/087; H04W 76/15

(57) ABSTRACT

Methods and devices are disclosed for improving audio quality in a multi-subscription wireless communication device having a first subscription associated with a first radio frequency (RF) resource, and a second subscription associated with a second RF resource. The wireless communication device may detect an active voice call on a modem stack associated with the first subscription, detect an active voice call on a modem stack associated with the second subscription, determine whether audio data processing for the active voice calls will conflict in time based on a first packet exchange timeline and a second packet exchange timeline, and misalign the audio data processing for the active voice call on the modem stack associated with the second subscription in response to determining that audio data processing for the active voice calls will conflict in time.

### BACKGROUND

Multi-subscription wireless devices are popular because of their flexibility in service options and other features. In various types of multi-subscription wireless communication devices, each modem stack is associated with a subscription and may store information provisioned by its respective network operator, which may allow the use of various different communication services. For example, various wireless networks may be configured to handle different types of data, use different communication modes, implement different radio access technologies, etc. One type of multi-subscription wireless device, referred to as a multi-subscription multi-active (MSMA) device, is typically configured with separate transmit/receive chains associated with each subscription, thereby allowing simultaneous active connections, including voice calls, with the networks corresponding to two subscriptions.

Such voice calls generally involve audio processing, such as encoding and decoding of audio data passed between, for example, a modem and an audio processor. The timing of audio data processing for each subscription is typically synchronized to the start of a connected-mode discontinuous reception (CDRX) cycle implemented by the network in order to improve power efficiency. However, in a multi-subscription device, two or more subscriptions may be connected to the same network or to different networks that follow the same CDRX cycle, causing audio processing tasks for uplink and downlink packets to occur at the same time. Further, during simultaneous voice calls on multiple subscriptions, the level of concurrency and number of tasks in the system may be increased as a result of processing multiple uplink and downlink data streams through multiple protocol stacks. As a result, the modem may be unable to adhere to the timeline for audio data processing for both subscriptions.

### SUMMARY

Various aspects include methods that may enable a processor of a wireless device for improving audio quality in a multi-subscription wireless communication device having at least a first subscription associated with a first radio frequency (RF) resource and a second subscription associated with a second RF resource. Various aspects may include detecting an active voice call on a modem stack associated with the first subscription in which a first packet exchange timeline is established between an audio processor and the modem stack associated with the first subscription, detecting an active voice call on a modem stack associated with the second subscription in which a second packet exchange timeline is established between the audio processor and the modem stack associated with the second subscription, determining whether audio data processing for the active voice calls will conflict in time based on the first packet exchange timeline and the second packet exchange timeline, and misaligning the audio data processing for the active voice call on the modem stack associated with the second subscription in response to determining that audio data processing for the active voice calls will conflict in time.

In some aspects, misaligning the audio data processing for the active voice call on the modem stack associated with the second subscription may include shifting the second packet exchange timeline by a delay relative to the first packet exchange timeline for each of uplink packet transmission and downlink packet reception. In some aspects, misaligning the audio data processing for the active voice call on the modem stack associated with the second subscription may include configuring the second packet exchange timeline to be randomly initialized.

In some aspects, determining whether audio data processing for the active voice calls will conflict in time based on the first packet exchange timeline and the second packet exchange timeline may include determining whether an access network for the active voice call on the modem stack associated with the first subscription matches an access network for the active voice call on the modem stack associated with the second subscription.

In some aspects, determining whether audio data processing for the active voice calls will conflict in time based on the first packet exchange timeline and the second packet exchange timeline may also include identifying a connected discontinuous reception (CDRX) cycle set by the access network for each of the active voice calls in response to determining that the access network for the active voice call on the modem stack associated with the first subscription does not match the access network for the active voice call on the modem stack associated with the second subscription, and determining whether the identified CDRX cycles are the same.

Various aspects may also include detecting an end of the active voice call on the modem stack associated with the first subscription, determining whether the active voice call on the modem stack associated with the second subscription is ongoing, and realigning the audio data processing for the active voice call on the modem stack associated with the second subscription based on the second packet exchange timeline in response to determining that audio data processing for the active voice calls will conflict in time.

Further aspects may include a wireless device having a processor configured to perform one or more operations of any of the methods summarized above. Further aspects may include a non-transitory processor-readable storage medium having stored thereon processor-executable instructions configured to cause a processor of a wireless device to perform operations of any of the methods summarized above. Further aspects include a wireless device having means for performing functions of the methods summarized above. Further aspects include a system on chip for use in a wireless device that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments, and together with the descriptions of various embodiments, serve to explain the features herein.

FIG. 1A is a communication system block diagram of a network suitable for use with various embodiments.

FIG. 1B is system block diagram of an Evolved Packet System (EPS) suitable for use with various embodiments.

FIG. 2A is a block diagram illustrating a wireless communication device according to various embodiments.

FIG. 2B is a block diagram illustrating an example configuration of components associated with audio data processing on a wireless communication device according to various embodiments.

FIG. 2C is a block diagram illustrating an example of a system-in-a-package (SIP) processing device suitable for implementing various embodiments.

FIGS. 3A-3C are example timelines illustrating data exchange between a modem and an audio processor supporting voice calls on each of two subscriptions of a wireless communication device.

FIG. 4 is a process flow diagram illustrating methods for improving audio quality for simultaneous voice calls in a multi-active multi-subscription wireless communication device according to various embodiments.

FIG. 5 is a component diagram of an example wireless device suitable for use with various embodiments.

FIG. 6 is a component diagram of another example wireless device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Systems, methods, and devices of various embodiments enable a wireless communication device configured to allow simultaneous active voice calls on at least two subscriptions to avoid concurrent audio data processing. In particular, various embodiments avoid concurrent audio data processing misaligning a preestablished timeline for packet exchange between the modem and audio processor corresponding to least one subscription. In this manner, audio data may be actively processed for the voice call on one subscription at a time, thereby preventing the modem from missing the scheduled opportunity to provide audio data to or receive audio data from the audio processor.

As used herein, the terms “subscription,” “SIM,” “SIM card,” and “subscriber identity module” are used interchangeably to refer to an International Mobile Subscriber Identity (IMSI), related key, and/or other information used to identify and/or authenticate a wireless device on a network and enable a communication service with the network, and/or a memory (e.g., integrated circuit or embedded into a removable card) on which such information is stored. Because the information stored in a SIM enables the wireless device to establish a communication link for a particular communication service or services with a particular network, the term “SIM” is also be used herein as a shorthand reference to the communication service associated with and enabled by the information stored in a particular SIM as the SIM and the communication network, as well as the services and subscriptions supported by that network, correlate to one another. Similarly, the term SIM may also be used as a shorthand reference to the protocol stack and/or modem stack and communication processes used in establishing and conducting communication services with subscriptions and networks enabled by the information stored in a particular SIM.

A SIM in various embodiments may be a Universal Integrated Circuit Card (UICC) that is configured with SIM and/or USIM applications, enabling access to GSM and/or Universal Mobile Telecommunications Service (UMTS) networks. The UICC may also provide storage for a phone book and other applications. Alternatively, in a CDMA network, a SIM may be a UICC removable user identity module (R-UIM) or a CDMA subscriber identity module (CSIM) on a card. In some networks, a SIM may be referred to as a Universal SIM (USIM). For ease of reference, the term “SIM” is used to refer to all forms of subscriber identify modules used in various radio access networks and network protocols.

Modern mobile communication devices (e.g., smartphones) may each include one or more SIM cards containing SIMs that enable a user to connect to different mobile networks while using the same mobile communication device. Each SIM serves to identify and authenticate a subscriber using a particular mobile communication device, and each SIM is associated with only one subscription. For example, a SIM may be associated with a subscription to one of GSM, TD-SCDMA, CDMA2000, and W-CDMA. As used herein, the terms “multi-SIM wireless communication device,” “multi-SIM wireless device,” and “dual-SIM wireless communication device,” are used interchangeably to describe a wireless device that is configured with more than one SIM.

As used herein, the terms “multi-SIM multi-active communication device” and “MSMA communication device” are used interchangeably to refer to a multi-SIM wireless communication device that is configured to use separate RF resources to independently handle communications with networks of two or more subscriptions. Dual-SIM dual-active (DSDA) communication devices are an example of a type of MSMA communication device.

The terms “wireless network,” “cellular network,” and “cellular wireless communication network” are used interchangeably herein to refer to a portion or all of a wireless network of a carrier associated with a wireless device and/or subscription on a wireless device.

As used herein, the terms “connected discontinuous reception mode,” “CDRX mode,” and “CDRX cycle” may interchangeably refer to a connected state process that involves alternating between an “On duration” (CDRX-on period) in which the downlink control channel is continuously monitored for scheduling messages, and an “Off duration” (CDRX-off period) period in which reception of downlink channels may be skipped to save power, with downlink traffic buffered until the next CDRX-on period. The length of a CDRX cycle, measured as the interval between the start of a CDRX-on period and the start of the next CDRX-on period, may be dynamically configured based on the amount of time between data transfers.

Wireless communication networks are widely deployed to provide various communication services such as voice, packet data, broadcast, messaging, and so on. These wireless networks may be capable of supporting communications for multiple users by sharing the available network resources. Examples of such wireless networks include the Global System for Mobile Communications (GSM), Code Division Multiple Access (CDMA) networks, Time Division Multiple Access (TDMA) networks, and Frequency Division Multiple Access (FDMA) networks. Wireless networks may also utilize various radio technologies such as Wideband-CDMA (W-CDMA), CDMA2000, Global System for Mobile Communications (GSM), etc. While reference may be made to procedures set forth in GSM standards such references are provided merely as examples, and the claims encompass other types of cellular telecommunication networks and technologies.

As used herein, the term “RF resource” refers to the components in a wireless communication device that send, receive, and decode radio frequency signals. An RF resource typically includes a number of components coupled together that transmit RF signals that are referred to as a “transmit chain,” and a number of components coupled together that receive and process RF signals that are referred to herein as a “receive chain.”

While specific receiver operations may be described herein with reference to a degree of two (i.e., two RF resources, two antennas, two receive chains, etc.), such references are used as example and are not meant to preclude embodiments using three or more RF resources. The terms “receiver” and/or “transmitter” may respectively indicate a receive chain and/or transmit chain, and/or portions thereof in use for radio links. Such portions of the receive chain and/or transmit chain may be parts of the RF resource that include, without limitation, an RF front end, components of the RF front end (including a receiver unit and/or transmitter unit), antennas, etc. Portions of a receive chain and/or transmit chain may be integrated into a single chip, or distributed over multiple chips. Also, the RF resource, or the parts of the RF resource, may be integrated into a chip along with other functions of the wireless device. Further, in some embodiment wireless systems, the wireless communication device may be configured with more RF resources than spatial streams, thereby enabling receive and/or transmit diversity to improve signal quality.

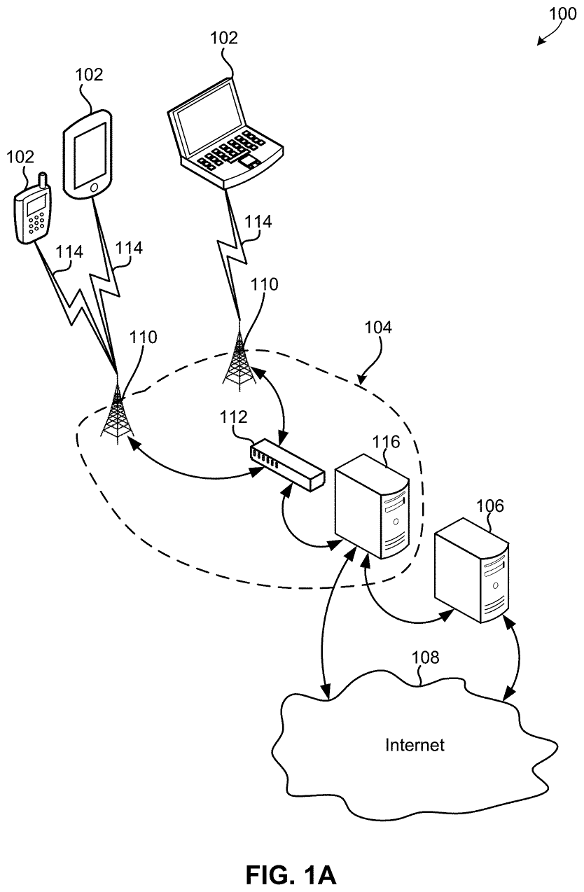

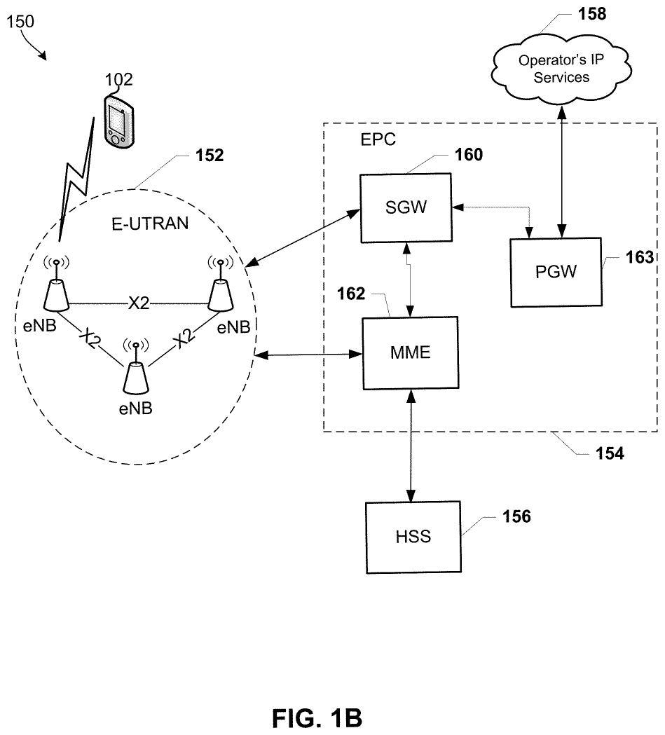

Various embodiments may be implemented within a variety of communication systems, such as the example communication system 100 illustrated in FIG. 1A. The communication system 100 may include one or more wireless communication devices 102, a telephone network 104, and network servers 106 coupled to the telephone network 104 and to the Internet 108. In some embodiments, the network server 106 may be implemented as a server within the network infrastructure of the telephone network 104.

A typical telephone network 104 may include a plurality of cell base stations 110 coupled to a network operations center 112, which operates to connect voice and data calls between the wireless communication devices 102 (e.g., tablets, laptops, cellular phones, etc.) and other network destinations, such as via telephone land lines (e.g., a plain old telephone system (POTS) network, not shown) and the Internet 108. The telephone network 104 may also include one or more servers 116 coupled to or within the network operations center 112 that provide a connection to the Internet 108 and/or to the network servers 106. Communications between the wireless communication devices 102 and the telephone network 104 may be accomplished via two-way wireless communication links 114, such as GSM, UMTS, CDMA, TDMA, LTE, and/or other communication technologies.

In general, any number of wireless networks may be deployed in a given geographic area. Each wireless network may support one or more radio access technologies, which may operate on one or more frequencies (also referred to as a carrier, channel, frequency channel, etc.) in the given geographic area in order to avoid interference between wireless networks of different radio access technologies.

Upon power up, the wireless communication device 102 may search for wireless networks from which the wireless communication device 102 can receive communication service. In various embodiments, the wireless communication device 102 may be configured to prefer LTE networks when available by defining a priority list in which LTE frequencies occupy the highest spots. The wireless communication device 102 may perform registration processes on one of the identified networks (referred to as the serving network), and the wireless communication device 102 may operate in a connected mode to actively communicate with the serving network. Alternatively, the wireless communication device 102 may operate in an idle mode and camp on the serving network if active communication is not required by the wireless communication device 102. In the idle mode, the wireless communication device 102 may identify all RATs in which the wireless communication device 102 is able to find a “suitable” cell in a normal scenario or an “acceptable” cell in an emergency scenario, as specified in the LTE standards, such as 3GPP TS 36.304 version 8.2.0 Release 8, entitled “LTE; Evolved Universal Terrestrial Radio Access (E-UTRA); User Equipment (UE) procedures in idle mode.”

The wireless communication device 102 may camp on a cell belonging to the radio access technology (RAT) with the highest priority among all identified. The wireless communication device 102 may remain camped until either the control channel no longer satisfies a threshold signal strength or a cell of a higher priority RAT reaches the threshold signal strength. Such cell selection/reselection operations for the wireless communication device 102 in the idle mode are also described in 3GPP TS 36.304 version 8.2.0 Release 8.

FIG. 1B illustrates a network architecture 150 that includes an Evolved Packet System (EPS). With reference to FIGS. 1A-1B, in the network architecture 150 the wireless communication device 102 may be connected to an LTE access network, for example, an Evolved UMTS Terrestrial Radio Access Network (E-UTRAN) 152. In the various embodiments, the E-UTRAN 152 may be a network of LTE base stations (i.e., eNBs) (e.g., 110 in FIG. 1A), which may be connected to one another via an X2 interface (e.g., backhaul).

In various embodiments, each eNB may provide to wireless devices an access point to an LTE core (e.g., an Evolved Packet Core). For example, the EPS in the network architecture 150 may further include an Evolved Packet Core (EPC) 154 to which the E-UTRAN 152 may connect. In various embodiments, the EPC 154 may include at least one Mobility Management Entity (MME) 162, a Serving Gateway (SGW) 160, and a Packet Data Network (PDN) Gateway (PGW) 163.

In various embodiments, the E-UTRAN 152 may connect to the EPC 154 by connecting to the SGW 160 and to the MME 162 within the EPC 154. The MME 162, which may also be logically connected to SGW 160, may handle tracking and paging of the wireless communication device 102 and security for E-UTRAN access on the EPC 154. The MME 162 may be linked to a Home Subscriber Server (HSS) 156, which may support a database containing user subscription, profile, and authentication information. Further, the MME 162 provides bearer and connection management for user Internet Protocol (IP) packets, which are transferred through the SGW 160. In various embodiments, the SGW 160 may be connected to the PGW 163, which may provide IP address allocation to the wireless communication device 102, as well as other functions. The PGW 163 may be connected to the Operator's IP Services 158, which may include, for example, the Internet, an Intranet, an IP Multimedia Subsystem (IMS), a PS Streaming Service (PSS), etc.

In various embodiments, modulation and multiple access schemes may be employed by a high speed access network (e.g., E-UTRAN 152) and may vary depending on the particular telecommunications standard being deployed. For example, in LTE applications, orthogonal frequency-division multiple access (OFDMA) may be used on the downlink, while single-carrier frequency-division multiple access (SC-FDMA) may be used on the uplink to support both frequency division duplexing (FDD) and time division duplexing (TDD). Those of ordinary skill in the art will appreciate that while the various embodiments herein may be described with respect to LTE, such embodiments but may be extended to other telecommunication standards employing other modulation and multiple access techniques. By way of example, the various embodiments may be extended to Evolution-Data Optimized (EV-DO) and/or Ultra Mobile Broadband (UMB), each of which are air interface standards promulgated by the 3rd Generation Partnership Project 2 (3GPP2) as part of the CDMA2000 family to provide broadband Internet access to wireless devices. The various embodiments may also be extended to Universal Terrestrial Radio Access (UTRA) employing Wideband-CDMA (W-CDMA), GSM, Evolved UTRA (E-UTRA), Ultra Mobile Broadband (UMB), IEEE 802.11 (Wi-Fi), IEEE 802.16 (WiMAX), IEEE 802.20, and/or Flash-OFDM employing OFDMA. The actual wireless communication standard and the multiple access technology employed depend on the specific application and the overall design constraints imposed on the system.

Various embodiments may be implemented in LTE-Advanced wireless networks that have been deployed or that may be deployed in the future. LTE-Advanced communications typically use spectrum in up to 20 MHz bandwidths allocated in a carrier aggregation of up to a total of 100 MHz (5 component carriers) used for transmission in each direction. Such LTE-Advanced systems may utilize one or more of two types of carrier aggregation, non-continuous and continuous. Non-continuous carrier aggregation involves aggregating available component carriers (inter- or intra-band) that are separated in the frequency spectrum, while continuous carrier aggregation involves multiple available component carriers that are adjacent to each other. Both non-continuous and continuous carrier aggregation may aggregate multiple LTE/component carriers to serve a wireless communication device using the LTE-Advanced protocol.

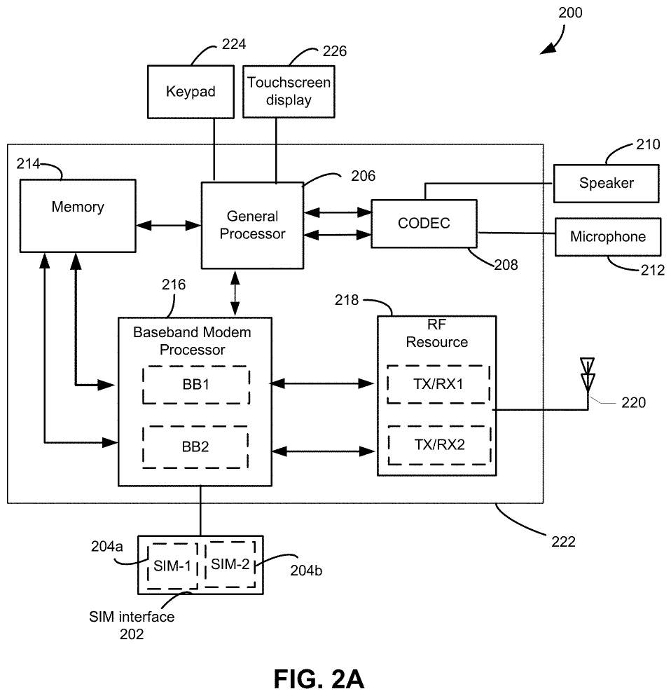

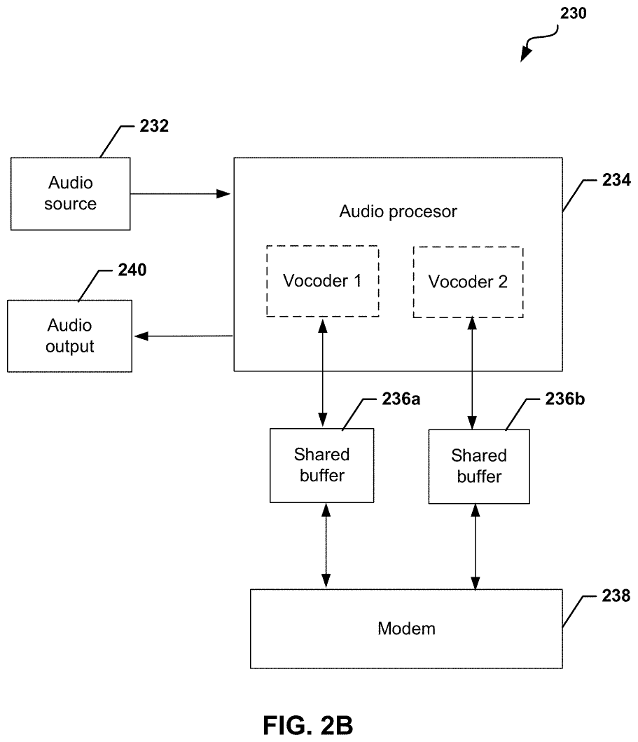

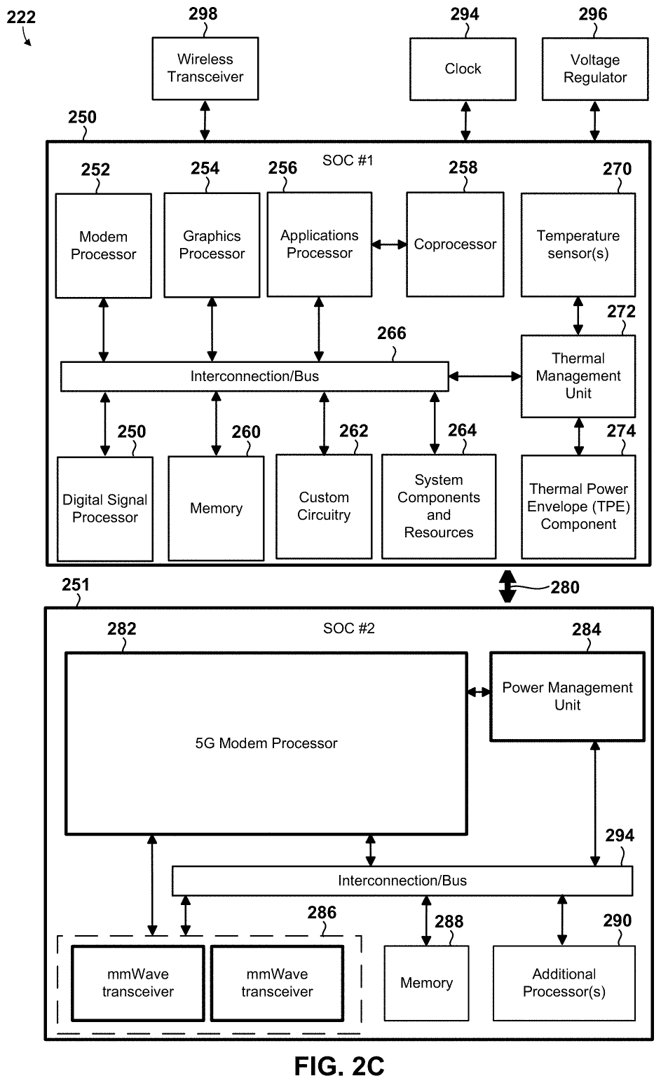

FIG. 2A is a functional block diagram of an example multi-SIM wireless device 200 that is suitable for implementing various embodiments. With reference to FIGS. 1A-2A, the wireless device 200 may be similar to one or more of the wireless communication devices 102 as described. The wireless device 200 may include a SIM interface 202, which may represent either one or two (or more) SIM interfaces. The SIM interface 202 may receive a first identity module SIM 204a that is associated with the first subscription, and a second identity module SIM 204b that is associated with the second subscription.

Each SIM 204a, 204b may have a CPU, ROM, RAM, EEPROM and I/O circuits. A SIM 204a, 204b used in various embodiments may contain user account information, an IMSI a set of SIM application toolkit (SAT) commands and storage space for phone book contacts. A SIM 204a, 204b may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on the SIM card for identification.

The wireless device 200 may include at least one controller, such as a general purpose processor 206, which may be coupled to at least one coder/decoder (CODEC) 208. In various embodiments, the wireless device 200 may implement more than one CODEC 208 and/or multiple instances of the same CODEC 208 in order to enable performing simultaneous active voice communications associated with different subscriptions

The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to the first or second subscription though a corresponding baseband-RF resource chain. The memory 214 may store operating system (OS), as well as user application software and executable instructions.

The general purpose processor 206 and the memory 214 may each be coupled to at least one baseband-modem processor 216. Each SIM 204 in the wireless device 200 may be associated with a baseband-RF resource chain that includes a baseband-modem processor 216 and at least one transmit/receive block (e.g., TX/RX1, TX/RX2) of an RF resource 218. In various embodiments, baseband-RF resource chains may include physically or logically separate baseband modem processors (e.g., BB1, BB2).

The RF resource 218 may be coupled to one or more antennas 220 and may perform transmit/receive functions for the wireless services associated with each SIM 204a, 204b of the wireless device 200. In some embodiments, the RF resource 218 may be coupled to multiple antennas 220 for sending and receiving RF signals associated with multiple subscriptions, thereby enabling the wireless device 200 to perform simultaneous communications with separate networks and/or service associated with multiple subscriptions. The RF resource 218 may include separate receive and transmit functionalities, or the RF resource 218 may include a transceiver that combines transmitter and receiver functions. In various embodiments, the transmit and receive functionalities of the RF resource 218 may be implemented by two or more transmit/receive blocks (TX/RX1, TX/RX2), which may represent circuitry associated with one or more radio access technologies.

In some embodiments, the general purpose processor 206, memory 214, baseband-modem processor(s) 216, and RF resource 218 may be included in a system-on-chip (SOC) or system-in-a-package (SIP) processing device 222. The one or more SIMs 204a, 204b and corresponding interface(s) 202 may be external to the SIP processing device 222. Further, various input and output devices may be coupled to components of the SIP processing device 222, such as interfaces or controllers. Example user input components suitable for use in the wireless device 200 may include, but are not limited to, a keypad 224 and a touchscreen display 226. Further details of an example SIP processing device 222 are described with reference to FIG. 2C.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in the wireless device 200 to enable communication between them, as is known in the art.

The baseband-modem processor of a wireless communication device may be configured to execute software including at least one protocol stack associated with at least one SIM. SIMs and associated protocol stacks may be configured to support a variety of communication services that fulfill different user requirements. Further, a particular SIM may be provisioned with information to execute different signaling procedures for accessing a domain of the core network associated with these services and for handling data thereof.

As described, a wireless communication device in the various embodiments may support a number of RATs to support communication with different wireless networks. For example, the radio technologies may include a wide area network (e.g., third generation partnership project (3GPP) long term evolution (LTE) or 1× radio transmission technology (1×)), wireless local area network (WLAN), Bluetooth and/or the like. Multiple antennas and/or receive blocks may be provided to facilitate multimode communication with various combinations of antenna and receiver/transmitter configurations. Each radio technology may transmit or receive signals via one or more antennas.

In various embodiments, the RF resource 218 may be configured with receiver and transmitter circuitry to support multiple radio access technologies/wireless networks that operate according to different wireless communication protocols. Such circuitry may allow the RF resource 218 to process signals associated with different communication standards, and may include or provide connections to different sets of amplifiers, digital to analog converters, analog to digital converters, filters, voltage controlled oscillators (VCOs), etc.

Wireless devices configured with multiple subscriptions may be capable of independently handling communications with networks associated with each subscription.

FIG. 2B illustrates a configuration 230 of elements that may interact in a wireless communication device to provide communication via VoIP, such as Voice-over-LTE (VoLTE). Referring to FIGS. 1A-2B, such elements in the configuration 230 may be functions and/or components of one of the wireless devices 102, 104, or 200, and may be associated with voice calls enabled on a first subscription and a second subscription (e.g., SIMs 204a, 204b). In configuration 230 on a wireless communication device (e.g., 102, 200), audio input associated with a voice call may be received by an audio source 232, The audio source 232 may include a microphone (e.g., 212), as well as an audio sampling circuit and an audio input buffer for storing audio samples (e.g., pulse modulation code (PCM) samples). Audio samples may be provided from the audio source 232 to an audio processor 234 in various embodiments. For example, the audio processor 234 may read samples out from the audio input buffer of the audio source 232 for encoding into audio packets. In various embodiments, the audio processor 234 may be implemented as one or more digital signal processors (DSP), one or more CODECs (e.g., 208) such as a vocoder, one or more general processors (e.g., 206), and/or logical units within one or more of such components. In various embodiments, a separate vocoder instance may be executed on the audio processor 234 corresponding to each subscription to enable simultaneous active VoIP calls.

The audio processor 234 may use any of a number of encoding schemes, depending on the capabilities/communication standards implemented by the network and the wireless device. Examples of encoding schemes supported by GSM include, but are not limited to, Regular Pulse Excitation and Linear Predictive Coding (RPE-LPC), Adaptive Multi-Rate (AMR), AMR Wideband (AMR-WB), etc. The audio processor 234 may also use any of a number of different compression techniques that are known in the art to reduce the amount of data for each 20 ms block. In various embodiments, the resulting data compression may depend on the techniques used in the particular encoding scheme. In some embodiments, the encoded audio data may be subjected to error detection and correction processes (e.g., channel coding, interleaving, ciphering, etc.) to prevent degradation over the air interface during transmission.

From the encoded audio packets, the audio processor 234 may generate uplink data packets according to a transmission protocol (e.g., real-time protocol (RTP). In various embodiments, the uplink data packets may be passed from the audio processor 234 to a shared buffer 236a or 236b corresponding to the vocoder instance and subscription associated with the particular VoIP call to which each packet belongs. The data packets may be retrieved from the shared buffer 236a, 236b by a modem 238 for uplink transmission to a network. The modem 238 may be implemented as a function of or more baseband-modem processor (e.g., 216), one or more application processors (e.g., 206), and/or other logical units within the same structures. In various embodiments, the modem may include any one or more components performing functions to transmit or receive communication data associated with a particular subscription. In some embodiments, referring to FIG. 2A, functional components of the RF resource 218 (e.g., TX/RX 1 or TX/RX2) may be employed for communications with multiple subscriptions.

With respect to reception of audio data, the modem 238 may receive encoded downlink data packets (e.g., RTP packets) during a voice call on one of the subscriptions. The received packets may be passed to the shared buffer 236a or 236b corresponding to the vocoder instance and subscription associated with the particular VoIP call to which each packet belongs. The audio processor 234 may retrieve the audio packets from the shared buffer 236a or 236b, and extract and decode the audio data using the appropriate vocoder instance. The decoded audio data may be provided to an audio output 240, such as a digital-to-analog converter and a speaker (e.g., 210). In various embodiments, the decoded audio data may be provided from the audio processor 234 to an audio output buffer before being passed to the audio output 240.

In various embodiments, separate units of a baseband-modem processor (e.g., 216) and of a CODEC (e.g., 208) in a multi-subscription device (e.g., 200) may be implemented as separate structures or as separate logical units within the same structure, and may be configured to execute software including at least two protocol stacks/modem stacks associated with at least two subscriptions, respectively. The subscriptions and associated modem stacks may be configured to support a variety of communication services that fulfill different user requirements. Further, a particular subscription may be provisioned with information to execute different signaling procedures for accessing a domain of the core network associated with these services and for handling data thereof.

Separate units of the baseband-modem processor of the multi-SIM wireless device may be implemented as separate structures or as separate logical units within the same structure, and may be configured to execute software including at least two protocol/modem stacks associated with at least two SIMs, respectively. The SIMs and associated modem stacks may be configured to support a variety of communication services that fulfill different user requirements. Further, a particular SIM may be provisioned with information to execute different signaling procedures for accessing a domain of the core network associated with these services and for handling data thereof.

Various embodiments may be implemented in a processing system within a wireless device, including a system-on-chip (SOC) or SIP 222. FIG. 2C illustrates an example processing system or SIP 222 architecture that may be used in wireless devices implementing various embodiments.

With reference to FIGS. 1-2C, the illustrated example SIP processing device 222 includes two SOCs 250, 251 coupled to a clock 294, a voltage regulator 296, and a wireless transceiver 298 configured to send and receive wireless communications via an antenna (not shown) to/from wireless devices, such as a base station 110. In some embodiments, the first SOC 250 operate as central processing unit (CPU) of a wireless device (e.g., 102) that carries out the instructions of software application programs by performing the arithmetic, logical, control and input/output (I/O) operations specified by the instructions. In some embodiments, the second SOC 251 may operate as a specialized processing unit. For example, the second SOC 251 may operate as a specialized 5G processing unit responsible for managing high volume, high speed (e.g., 5 Gbps, etc.), and/or very high frequency short wave length (e.g., 28 GHz millimeter wave (mmWave) spectrum, etc.) communications.

The first SOC 250 may include a digital signal processor (DSP) 250, a modem processor 252, a graphics processor 254, an application processor 256, one or more coprocessors 258 (e.g., vector co-processor) connected to one or more of the processors, memory 260, custom circuity 262, system components and resources 264, an interconnection/bus module 266, one or more temperature sensors 270, a thermal management unit 272, and a thermal power envelope (TPE) component 274. The second SOC 251 may include a 5G modem processor 282, a power management unit 284, an interconnection/bus module 292, a plurality of mmWave transceivers 286, memory 288, and various additional processors 290, such as an applications processor, packet processor, etc.

Each processor 250, 252, 254, 256, 258, 282, 290 may include one or more cores, and each processor/core may perform operations independent of the other processors/cores. For example, the first SOC 250 may include a processor that executes a first type of operating system (e.g., FreeBSD, LINUX, OS X, etc.) and a processor that executes a second type of operating system (e.g., MICROSOFT WINDOWS 10). In addition, any or all of the processors 250, 252, 254, 256, 258, 282, 290 may be included as part of a processor cluster architecture (e.g., a synchronous processor cluster architecture, an asynchronous or heterogeneous processor cluster architecture, etc.).

The first and second SOC 250, 251 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 264 of the first SOC 250 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 264 and/or custom circuitry 262 may also include circuitry to interface with peripheral devices, such as cameras, electronic displays, wireless communication devices, external memory chips, etc.

The first and second SOC 250, 251 may communicate via interconnection/bus module 280. The various processors 250, 252, 254, 256, 258, may be interconnected to one or more memory elements 260, system components and resources 264, and custom circuitry 262, and a thermal management unit 272 via an interconnection/bus module 266. Similarly, the processor 282 may be interconnected to the power management unit 284, the mmWave transceivers 286, memory 288, and various additional processors 290 via the interconnection/bus module 292. The interconnection/bus module 266, 280, 292 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 250, 251 may further include an input/output module (not illustrated) for communicating with resources external to the SOC, such as a clock 294 and a voltage regulator 296. Resources external to the SOC (e.g., clock 294, voltage regulator 296) may be shared by two or more of the internal SOC processors/cores.

In addition to the example SIP 222 discussed above, various embodiments may be implemented in a wide variety of computing systems, which may include a single processor, multiple processors, multicore processors, or any combination thereof.

While described with respect to LTE, GSM and/or UMTS networks, these are merely examples of networks to which serving cells for associated with the modem stacks of various embodiments may belong.

That is, the exchange of packets between the modem and the audio processor (e.g., in FIG. 2B) for both uplink and downlink data is performed on a pre-agreed/scheduled timeline, using wakeup offsets and a shared buffer. The packet producer (e.g., modem or audio processor) ensures packets are available before the reader (i.e., modem or audio processor) wakes up and retrieves the packet from the shared buffer.

In LTE networks, a wireless device (or modem stack associated with LTE operations) may employ connected mode Discontinuous Reception (CDRX) to conserve battery power while staying in the Radio Resource Control (RRC) connected state. Therefore, CDRX parameters may be set to achieve a balance between minimizing packet delay maximizing power savings. Specifically, in the CDRX mode the wireless communication device may exploit the short periods of time during which no data is sent or received in a data communication session (e.g., during the packet arrival process when there are no outstanding or new packets to be sent or received). When the CDRX mode is enabled, the wireless communication device may cycle between periods of monitoring the physical downlink control channel (PDCCH) for downlink data (i.e., CDRX-on period) and periods in which the RF resource is not used and/or is powered down (i.e., CDRX-off period). In various embodiments, the access network (e.g., eNB) may configure a set of CDRX parameters for the wireless communication device (or modem stack associated with LTE operations), which may be selected based on the application type such that power and resource savings are maximized. In particular, the sleep (CDRX-off) and awake (CDRX-on) cycles for the wireless device may be set by a network (e.g., eNB) to which the wireless device is connected.

In various embodiments, a wakeup/sleep schedule for components configured to perform audio processing tasks (e.g., a modem and an audio processor) may be aligned with the CDRX cycle

The wakeup and sleep schedule followed by the modem and the audio processor for processing audio data associated with a subscription is pre-established/agreed upon, and includes offsets so that the writer ensures the packet is ready before the reader accesses the shared buffer in order to retrieve the packet. Typically, such pre-established timeline is synchronized to the CDRX cycle for the network to which the subscription is connected, with wakeup being as close to the CDRX-on period as possible in order to conserve power.

During an active voice call, the audio processor and modem wakeup to process a downlink packet and to process an uplink packet during the CDRX-on duration, downlink packet processing and uplink packet. Generating the preestablished audio processing timeline for packet exchange between the audio processor and the modem may involve setting the timing for two reference points—a transmit reference (“Tx-Reference” or “Tx-Ref”) and a receive reference (“Rx-Reference” or Rx-Ref”). Specifically, the Tx-Reference provides the time at which the modem wakes up to prepare a packet for uplink transmission, while the Rx-Reference provides the time at which the modem provides a received downlink packet to a shared buffer for decoding by the audio processor. The timing for corresponding wakeup and encoding on the audio processor may be slightly offset from the Tx-Reference, while the timing for decoding on the audio processor may be slightly offset from the Rx-Reference.

However, if multiple subscriptions are connected to a network or networks using the same CDRX cycle during simultaneous active voice calls, the timelines for activity on the audio processor and modem may be the same, leading to an increased chance of task preemption due to processor contention among competing threads across modules for processing audio data on both subscriptions. As a result, the timing of audio processing tasks on the modem and the audio processor for at least one of the subscriptions may be impacted. For example, the modem may not be able to honor the pre-agreed timeline for providing received downlink packets into the shared buffer for one or more of the subscriptions.

Additionally, the modem may be delayed in retrieving uplink voice packets from the shared butter for one of the subscriptions. As a result, the audio quality of one or both of the active calls may be degraded from delayed processing of received packets and/or missed transmit opportunities.

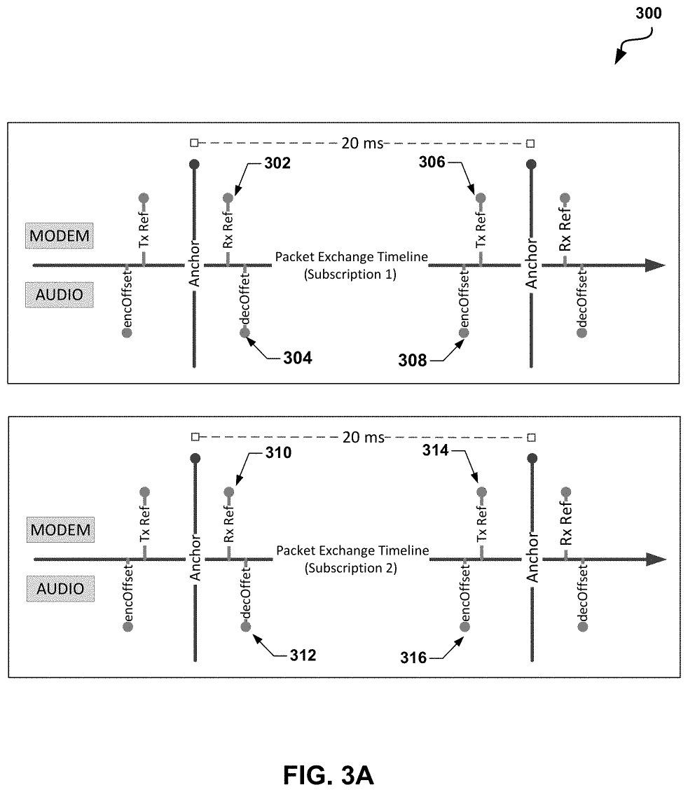

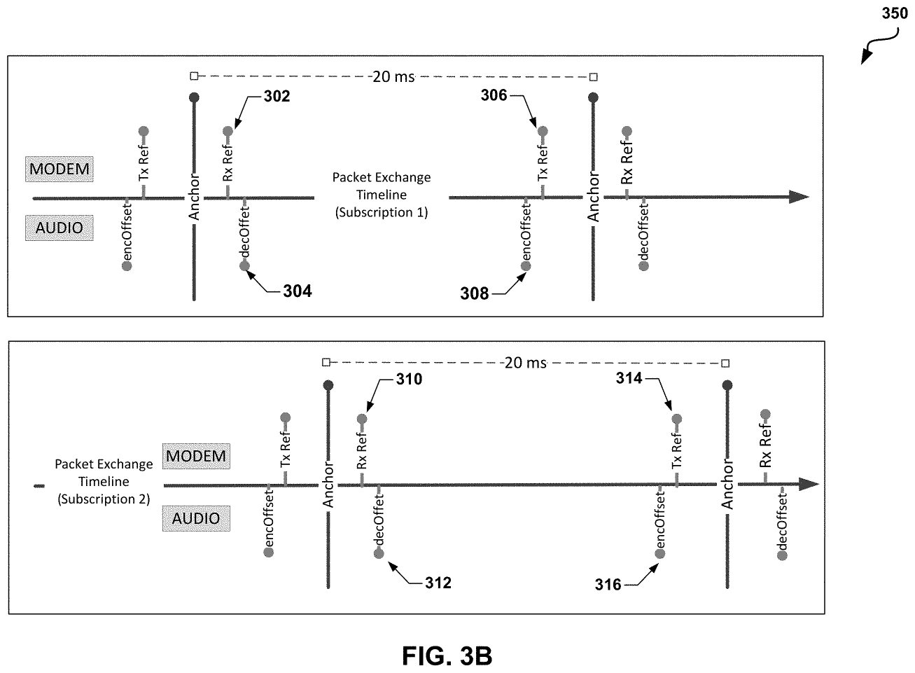

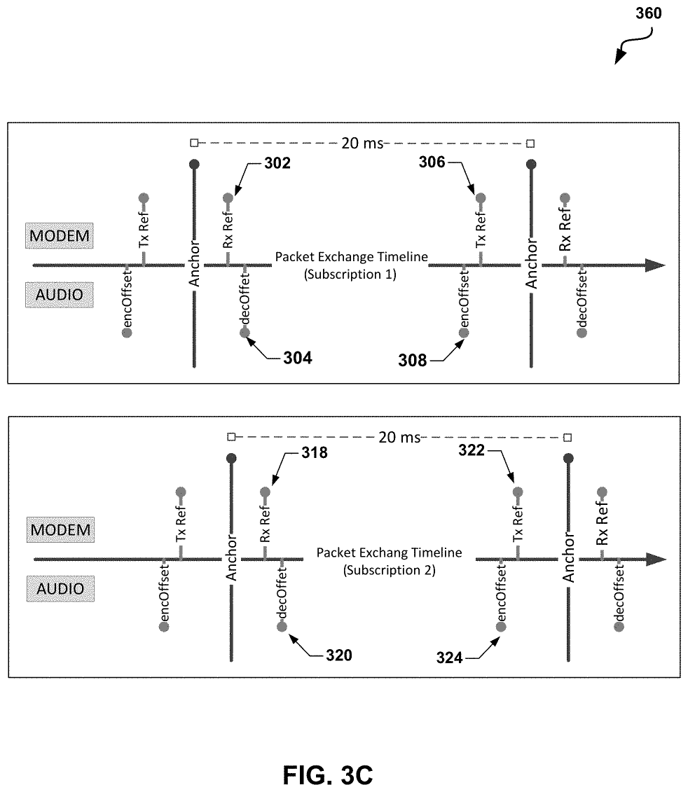

For example, FIG. 3A is a representative diagram 300 of a pre-agreed audio processing timeline during voice calls on two subscriptions of a multi-subscription wireless device connected to one or more networks having the same CDRX cycle. With reference to FIGS. 1A-3A, wakeups for audio uplink processing activities during a voice call (e.g., VoLTE) may be configured to occur every 20 ms, for example. The Rx-Reference 302, offset audio encoding time 304, Tx-Reference 306, and offset audio decoding time 308 are used for audio processing on the first subscription during an active voice call.

With respect to audio processing during the communication on the second subscription, the Rx-Reference 310, the offset audio encoding time 312, the Tx-Reference 314, and offset audio decoding time 316 are shown to occur at the same timing as the respective points on the first subscription due to the synchronization with the CDRX cycle.

In various embodiments, concurrent timelines for audio processing (e.g., packet exchange between the modem and audio processor) during simultaneous active voice calls on a multi-subscription device may be avoided by changing the timeline associated with one of the subscriptions. For example, in various embodiments, the pre-agreed audio processing timeline may be shifted for one of the subscriptions so as to delay the start of the vocoder and modem tasks associated with the voice call on that subscription.

For example, FIG. 3B is a representative diagram 350 of a pre-agreed audio processing timeline during a voice call on two subscriptions of a multi-subscription wireless device according to various embodiments. With reference to FIGS. 1A-3B, the Rx-Reference 302, offset audio decoding time 304, Tx-Reference 306, and offset audio encoding time 308 may be used for audio processing on the first subscription during an active voice call. With respect to audio processing during the active voice call on the second subscription, the Rx-Reference 310, the offset audio decoding time 312, the Tx-Reference 314, and offset audio encoding time 316 are shifted to be misaligned with the timing of the same respective points on the first subscription.

In various embodiments, the shift in the Tx-Reference 314 and the offset audio encoding time 316 may be a delay of a few milliseconds. In this manner, data packets may be produced by the audio processor, and retrieved by the modem from the shared buffer for uplink transmission, at times that do not conflict with the corresponding packet production and reading for uplink data on the first subscription.

In various embodiments, the shift in the Rx-Reference 310 and the offset audio decoding time 312 may be a delay of the same or a different amount of time (e.g., up to 40 ms). In this manner, the modem may provide received audio packets for the voice call on the second subscription into the shared buffer to be decoded by the audio processor after the corresponding processing of downlink packets for the first subscription has finished. In other words, the times in which uplink and downlink voice packets associated with the second subscription call are processed may be staggered with respect to the audio processing timeline for the first subscription call.

In some embodiments, the audio processing timeline for the call on the second subscription may be only slightly shifted relative to the audio processing timeline for the first subscription call. For example, FIG. 3C is a representative diagram 360 of a pre-agreed audio processing timeline during a voice call on two subscriptions of a multi-subscription wireless device according to various embodiments. With reference to FIGS. 1A-3C, the Rx-Reference 302, offset audio decoding time 304, Tx-Reference 306, and offset audio encoding time 308 may be used for audio processing on the first subscription during an active voice call. With respect to audio processing during the active voice call on the second subscription, the Rx-Reference 318, the offset audio decoding time 320, the Tx-Reference 322, and offset audio encoding time 324 are shifted to be misaligned with the timing of the same respective points on the first subscription.

In various embodiments, the slight shift in the Rx-Reference 318, the offset audio decoding time 320, the Tx-Reference 322, and the offset audio encoding time 324 may be a delay of only 1-2 milliseconds. This relatively small misalignment may allow over-the-air transmission of uplink data packets for the call on the second subscription to occur within the current CDRX cycle.

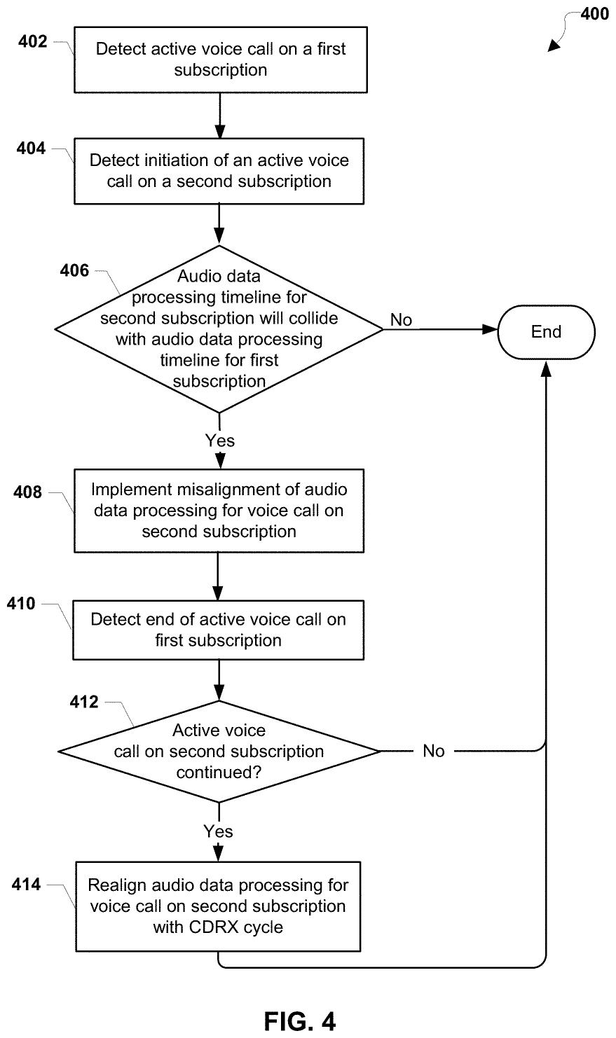

FIG. 4 illustrates a method 400 for avoiding conflicting audio data processing on a multi-subscription wireless communication device capable of simultaneous active voice calls according to various embodiments. With reference to FIGS. 1A-4, the operations of the method 400 may be implemented by one or more processors of the wireless device (e.g., 102, 104, 200 in FIGS. 1A-2) 200, such as the general purpose processor 206 and/or baseband modem processor(s) 216, or a separate controller (not shown) that may be coupled to the memory 214 and to the baseband modem processor(s) 216. While various embodiments are described as processes involving at least two subscriptions and RF resources, various embodiment may be implemented to manage various combinations of two or more subscriptions and/or RF resources

The references to the first and second subscriptions are arbitrary and used merely for the purposes of describing the embodiments. The wireless device processor may assign any indicator, name or other designation to differentiate communications or functions associated with one or more subscription and associated protocol stacks. Further, while the network(s)associated with the subscription(s) may be referenced as LTE, the various embodiments may be implemented for voice calls in any of a variety of high-speed networks (e.g., HSPA+, DC-HSPA, EV-DO, etc.).

In block 402, the processor may detect that an active voice call is established on a first subscription of the wireless device. In various embodiments, the wireless device may be connected to a network (e.g., an LTE network) supported by the first subscription, and the established active voice call may utilize VoLTE.

In block 404, the processor may detect initiation of an active voice call on a second subscription of the wireless device. In some embodiments, the wireless device may be connected to a network (e.g., an LTE network) supported by the second subscription, and the active voice call on the second subscription may utilize VoLTE. In various embodiments, the network associated with the second subscription may be the same as or different from the network associated with the first subscription.

In determination block 406, the processor may determine whether the audio data processing timeline for the voice call on the second subscription will collide with the audio data processing timeline for the voice call on the first subscription. In some embodiments, the audio data processing timeline established for each call may be a pre-established schedule for data packet exchange between the modem (e.g., 238) and the audio data processor (e.g., 236). For example, the pre-established schedule may include timing to perform wakeups and processing tasks associated with transmitting uplink and receiving downlink audio data for a particular subscription. In some embodiments, the audio data processing timeline for a voice call on a subscription may be synchronized to the CDRX cycle that is set by the corresponding network.

In some embodiments, determining whether the audio data processing timeline for the voice call on the second subscription will collide with the audio data processing timeline for the voice call on the first subscription in determination block 406 may involve determining whether the same CDRX cycle is employed by the network to which the wireless device is connected for each of the voice calls. For example, the processor may identify a first network associated with the active voice call on the first subscription and a second network associated with the active voice call on the second subscription. In some embodiments, the processor may determine whether the first network and the second network are the same, and therefore necessarily employ the same CDRX cycle for each of the voice calls. In some embodiments, the processor may determine whether a first network and second network that are different from one another employ the same CDRX cycle based on information provided by the network to carry out the active voice calls.

In response to determining that the audio data processing timeline for the voice call on the second subscription will not collide with the audio data processing timeline for the voice call on the first subscription (i.e., determination block 406=“No”), the method 400 may as there is no need to adjust audio data processing timelines.

In response to determining that the audio data processing timeline for the voice call on the second subscription will collide with the audio data processing timeline for the voice call on the first subscription (i.e., determination block 406=“Yes”), the processor may implement a misalignment of the audio data processing timeline for the voice call on the second subscription in block 408. In some embodiments, the processor may implement misalignment of the audio data processing timeline by shifting the timing for uplink and downlink packet exchange associated with the second subscription between the modem and the audio processor. For example, with respect to packet transmission in the uplink, the Tx-Reference and the corresponding offset audio encoding time for the second subscription may be staggered to occur a few milliseconds later. As a result, wakeup for transmitting a data packet associated with the second subscription on the modem and audio processor may occur after such processing has completed for a packet associated with the first subscription. In some embodiments, an uplink audio packet may be transmitted to the second network later in the CDRX-On window, or in the subsequent CDRX-On window.

With respect to downlink packet reception, the Rx-Reference and the corresponding offset audio decoding time may also be staggered to occur later. In some cases, wakeup for receiving and decoding of a data packet associated with the second subscription on the modem and audio processor may occur after such tasks are completed for a packet associated with the first subscription. In some embodiments, access to a downlink audio packet received from the second network by the modem and audio processor may be delayed for an amount of time sufficient to allow processing and decoding of a downlink audio packet received from the first network. In some embodiments, the shift in the timing for packet exchange associated with the second subscription between the modem and the audio processor implemented by the processor may be the same or different in the uplink compared to the downlink. For example, in some embodiments a 3-4 ms shift may be employed for processing of uplink data packets for transmitted, while a 20-40 ms shift may be employed for processing of received downlink data packets.

In some embodiments, the processor may implement misalignment of the audio data processing timeline by configuring a randomly initialized timeline (i.e., independent of the CDRX cycle) for uplink and downlink packet exchange between the modem and audio processor associated with the second subscription. For example, with respect to packet transmission in the uplink, the Tx-Reference and the corresponding offset audio encoding time, as well as the Rx-Reference and the corresponding offset audio decoding time, may be randomly assigned to perform audio data processing associated with the second subscription.

The processor may detect the end of the active voice call on the first subscription in block 410, and in determination block 412, the processor may determine whether the active voice call on the second subscription has continued. In response to determining that the active voice call on the second subscription has end (i.e., determination block 412=“No”), the method 400 may end.

In response to determining that the active voice call on the second subscription is continuing (i.e., determination block 412=“Yes”), the processor may realign the audio data processing timeline for the active voice call with the CDRX cycle associated with second subscription in block 414. In various embodiments, the CDRX cycle associated with the second subscription may be the original preestablished timeline that is synchronized with the CDRX cycle set by the second network.

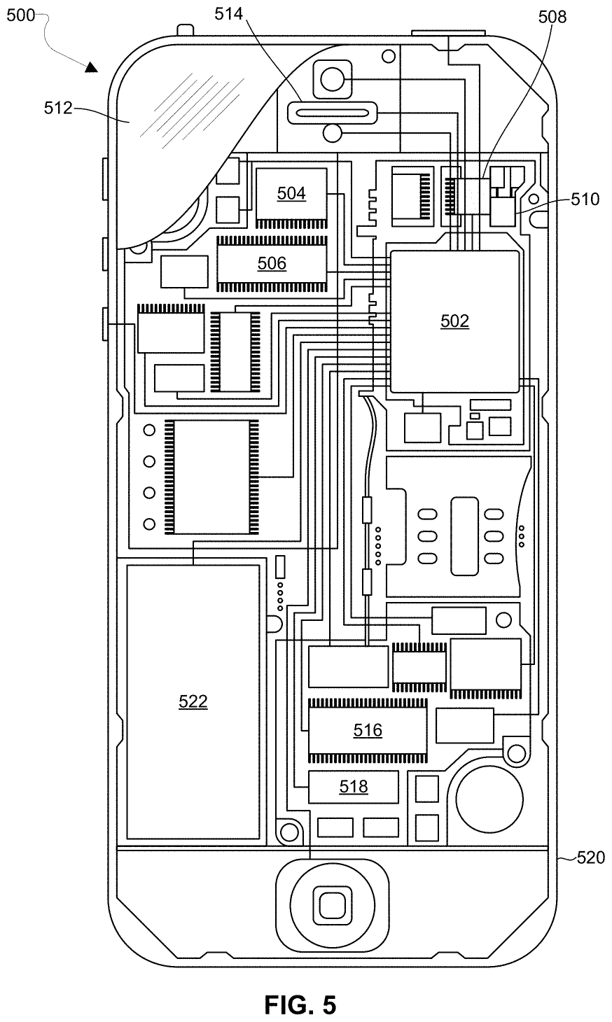

Various embodiments (including, but not limited to, the embodiments described with reference to FIG. 4) may be implemented in any of a variety of wireless devices, an example 500 of which is illustrated in FIG. 5. With reference to FIGS. 1A-5 ,the wireless device 500 (which may correspond, for example, to the wireless devices 102 and/or 200 in FIGS. 1A-2A) may include a processor 502 coupled to a touchscreen controller 504 and an internal memory 506. The processor 502 may be one or more multicore ICs designated for general or specific processing tasks. The internal memory 506 may be volatile or non-volatile memory, and may also be secure and/or encrypted memory, or unsecure and/or unencrypted memory, or any combination thereof.

The touchscreen controller 504 and the processor 502 may also be coupled to a touchscreen panel 512, such as a resistive-sensing touchscreen, capacitive-sensing touchscreen, infrared sensing touchscreen, etc. The wireless device 500 may have one or more radio signal transceivers 508 (e.g., Peanut®, Bluetooth®, Zigbee®, Wi-Fi, RF radio) and antennas 510, for sending and receiving, coupled to each other and/or to the processor 502. The transceivers 508 and antennas 510 may be used with circuitry in various embodiments to implement the various wireless transmission protocol stacks and interfaces. The wireless device 500 may include a cellular network wireless modem chip 516 that enables communication via a cellular network and is coupled to the processor. The wireless device 500 may include a peripheral device connection interface 518 coupled to the processor 502. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 518 may also be coupled to a similarly configured peripheral device connection port (not shown). The wireless device 500 may also include speakers 514 for providing audio outputs. The wireless device 500 may also include a housing 520, constructed of a plastic, metal, or a combination of materials, for containing all or some of the components discussed herein. The wireless device 500 may include a power source 522 coupled to the processor 502, such as a disposable or rechargeable battery. The rechargeable battery may also be coupled to the peripheral device connection port to receive a charging current from a source external to the wireless device 500.

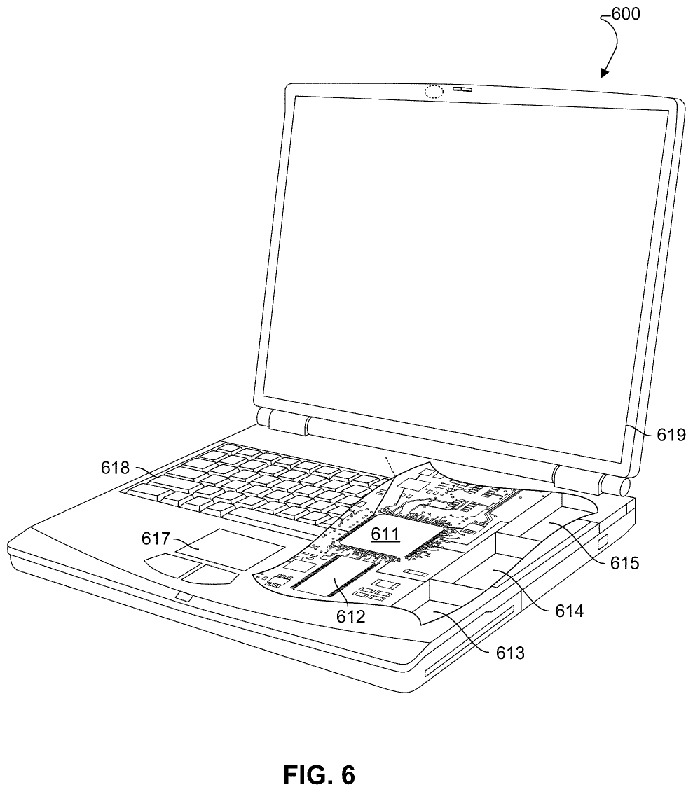

Various embodiments (including, but not limited to, the embodiments discussed with reference to FIG. 4), may also be implemented within a variety of personal computing devices, such as for video conferencing, an example 600 of which is illustrated in FIG. 6. With reference to FIGS. 1A-6, the laptop computer 600 (which may correspond, for example, to the wireless devices 102, 200 in FIGS. 1A-2A) may include a touchpad touch surface 617 that serves as the computer's pointing device, and thus may receive drag, scroll, and flick gestures similar to those implemented on wireless computing devices equipped with a touchscreen display as described. A laptop computer 600 will typically include a processor 611 coupled to volatile memory 612 and a large capacity nonvolatile memory, such as a disk drive 613 of Flash memory. The computer 600 may also include a floppy disc drive 614 and a compact disc (CD) drive 615 coupled to the processor 611. The computer 600 may also include a number of connector ports coupled to the processor 611 for establishing data connections or receiving external memory devices, such as a Universal Serial Bus (USB) or FireWire® connector sockets, or other network connection circuits for coupling the processor 611 to a network. In a notebook configuration, the computer housing includes the touchpad 617, the keyboard 618, and the display 619 all coupled to the processor 611. Other configurations of the computing device may include a computer mouse or trackball coupled to the processor (e.g., via a USB input) as are well known, which may also be used in conjunction with various embodiments.

With reference to FIGS. 1A-6, the processors 502 and 611 may be any programmable microprocessor, microcomputer or multiple processor chip or chips that can be configured by software instructions (applications) to perform a variety of functions, including the functions of various embodiments as described. In some devices, multiple processors may be provided, such as one processor dedicated to wireless communication functions and one processor dedicated to running other applications. Typically, software applications may be stored in the internal memory 506, 612 and 613 before they are accessed and loaded into the processors 502 and 611. The processors 502 and 611 may include internal memory sufficient to store the application software instructions. In many devices the internal memory may be a volatile or nonvolatile memory, such as flash memory, or a mixture of both. For the purposes of this description, a general reference to memory refers to memory accessible by the processors 502, 611, including internal memory or removable memory plugged into the device and memory within the processor 502 and 611, themselves.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit the various embodiments to a particular order, sequence, type of network or carrier.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of various embodiments are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

What is claimed is:

1. A method of improving audio quality in a multi-subscription wireless communication device having at least a first subscription associated with a first radio frequency (RF) resource, and a second subscription associated with a second RF resource, the method comprising:
detecting an active voice call on a modem stack associated with the first subscription, wherein a first packet exchange timeline is established between an audio processor and the modem stack associated with the first subscription;
detecting an active voice call on a modem stack associated with the second subscription, wherein a second packet exchange timeline is established between the audio processor and the modem stack associated with the second subscription;
determining whether audio data processing for the active voice calls will conflict in time based on the first packet exchange timeline and the second packet exchange timeline; and
misaligning the audio data processing for the active voice call on the modem stack associated with the second subscription in response to determining that audio data processing for the active voice calls will conflict in time.

2. The method of claim 1, wherein misaligning the audio data processing for the active voice call on the modem stack associated with the second subscription comprises:
shifting the second packet exchange timeline by a delay relative to the first packet exchange timeline for each of uplink packet transmission and downlink packet reception.

3. The method of claim 1, wherein misaligning the audio data processing for the active voice call on the modem stack associated with the second subscription comprises configuring the second packet exchange timeline to be randomly initialized.

4. The method of claim 1, wherein determining whether audio data processing for the active voice calls will conflict in time based on the first packet exchange timeline and the second packet exchange timeline comprises:
determining whether an access network for the active voice call on the modem stack associated with the first subscription matches an access network for the active voice call on the modem stack associated with the second subscription.

5. The method of claim 4, wherein determining whether audio data processing for the active voice calls will conflict in time based on the first packet exchange timeline and the second packet exchange timeline further comprises:
identifying a connected discontinuous reception (CDRX) cycle set by the access network for each of the active voice calls in response to determining that the access network for the active voice call on the modem stack associated with the first subscription does not match the access network for the active voice call on the modem stack associated with the second subscription; and
determining whether the identified CDRX cycles are the same.

6. The method of claim 1, further comprising:
detecting an end of the active voice call on the modem stack associated with the first subscription;
determining whether the active voice call on the modem stack associated with the second subscription is ongoing; and
realigning the audio data processing for the active voice call on the modem stack associated with the second subscription based on the second packet exchange timeline in response to determining that audio data processing for the active voice calls will conflict in time.

7. A wireless communication device, comprising:
a memory;
a first radio frequency (RF) resource associated with a first subscription and a second RF resource associated with a second subscription; and
a processor coupled to the memory, the first RF resource, and the second RF resources, and configured with processor-executable instructions to:
detect an active voice call on a modem stack associated with the first subscription, wherein a first packet exchange timeline is established between an audio processor and the modem stack associated with the first subscription; detect an active voice call on a modem stack associated with the second subscription, wherein a second packet exchange timeline is established between the audio processor and the modem stack associated with the second subscription;
determine whether audio data processing for the active voice calls will conflict in time based on the first packet exchange timeline and the second packet exchange timeline; and misalign the audio data processing for the active voice call on the modem stack associated with the second subscription in response to determining that audio data processing for the active voice calls will conflict in time.

8. The wireless communication device of claim 7, wherein the processor is further configured with processor-executable instructions to misalign the audio data processing for the active voice call on the modem stack associated with the second subscription by:
shifting the second packet exchange timeline by a delay relative to the first packet exchange timeline for each of uplink packet transmission and downlink packet reception.

9. The wireless communication device of claim 7, wherein the processor is further configured with processor-executable instructions to misalign the audio data processing for the active voice call on the modem stack associated with the second subscription by configuring the second packet exchange timeline to be randomly initialized.

10. The wireless communication device of claim 7, wherein the processor is further configured with processor-executable instructions to determine whether audio data processing for the active voice calls will conflict in time based on the first packet exchange timeline and the second packet exchange timeline by:
determining whether an access network for the active voice call on the modem stack associated with the first subscription matches an access network for the active voice call on the modem stack associated with the second subscription.

11. The wireless communication device of claim 10, wherein the processor is further configured with processor-executable instructions to determine whether audio data processing for the active voice calls will conflict in time based on the first packet exchange timeline and the second packet exchange timeline by: identifying a connected discontinuous reception (CDRX) cycle set by the access network for each of the active voice calls in response to determining that the access network for the active voice call on the modem stack associated with the first subscription does not match the access network for the active voice call on the modem stack associated with the second subscription; and
determining whether the identified CDRX cycles are the same.

12. The wireless communication device of claim 7, wherein the processor is further configured with processor-executable instructions to:
detect an end of the active voice call on the modem stack associated with the first subscription;
determine whether the active voice call on the modem stack associated with the second subscription is ongoing; and
realign the audio data processing for the active voice call on the modem stack associated with the second subscription based on the second packet exchange timeline in response to determining that audio data processing for the active voice calls will conflict in time.

13. A processing device configured for use in a wireless device including a first audio frequency (RF) resource and a second RF resource, comprising:
a processor configured with processor-executable instructions to:
detect an active voice call on a modem stack associated with a first subscription, wherein a first packet exchange timeline is established between an audio processor and the modem stack associated with the first subscription;
detect an active voice call on a modem stack associated with a second subscription, wherein a second packet exchange timeline is established between the audio processor and the modem stack associated with the second subscription;
determine whether audio data processing for the active voice calls will conflict in time based on the first packet exchange timeline and the second packet exchange timeline; and
misalign the audio data processing for the active voice call on the modem stack associated with the second subscription in response to determining that audio data processing for the active voice calls will conflict in time.

14. The processing device of claim 13, wherein the processor is further configured with processor-executable instructions to misalign the audio data processing for the active voice call on the modem stack associated with the second subscription by:
shifting the second packet exchange timeline by a delay relative to the first packet exchange timeline for each of uplink packet transmission and downlink packet reception.

15. A non-transitory processor-readable storage medium having stored thereon processor-executable instructions configured to cause a processor of a wireless device configured with a first radio frequency (RF) resource and a second RF resource to perform operations comprising:
detecting an active voice call on a modem stack associated with a first subscription, wherein a first packet exchange timeline is established between an audio processor and the modem stack associated with the first subscription;
detecting an active voice call on a modem stack associated with a second subscription, wherein a second packet exchange timeline is established between the audio processor and the modem stack associated with the second subscription;
determining whether audio data processing for the active voice calls will conflict in time based on the first packet exchange timeline and the second packet exchange timeline; and
misaligning the audio data processing for the active voice call on the modem stack associated with the second subscription in response to determining that audio data processing for the active voice calls will conflict in time.

16. The non-transitory processor-readable storage medium of claim 15, wherein the processor-executable instructions are configured to cause the processor of the wireless device to perform operations such that misaligning the audio data processing for the active voice call on the modem stack associated with the second subscription comprises:
shifting the second packet exchange timeline by a delay relative to the first packet exchange timeline for each of uplink packet transmission and downlink packet reception.

17. The non-transitory processor-readable storage medium of claim 15, wherein the processor-executable instructions are configured to cause the processor of the wireless device to perform operations such that misaligning the audio data processing for the active voice call on the modem stack associated with the second subscription comprises configuring the second packet exchange timeline to be randomly initialized.

18. The non-transitory processor-readable storage medium of claim 15, wherein the processor-executable instructions are configured to cause the processor of the wireless device to perform operations such that determining whether audio data processing for the active voice calls will conflict in time based on the first packet exchange timeline and the second packet exchange timeline comprises:
determining whether an access network for the active voice call on the modem stack associated with the first subscription matches an access network for the active voice call on the modem stack associated with the second subscription.

19. The non-transitory processor-readable storage medium of claim 18, wherein the processor-executable instructions are configured to cause the processor of the wireless device to perform operations such that determining whether audio data processing for the active voice calls will conflict in time based on the first packet exchange timeline and the second packet exchange timeline further comprises:
identifying a connected discontinuous reception (CDRX) cycle set by the access network for each of the active voice calls in response to determining that the access network for the active voice call on the modem stack associated with the first subscription does not match the access network for the active voice call on the modem stack associated with the second subscription; and
determining whether the identified CDRX cycles are the same.

20. The non-transitory processor-readable storage medium of claim 15, wherein the processor-executable instructions are configured to cause the processor of the wireless device to perform operations further comprising:
detecting an end of the active voice call on the modem stack associated with the first subscription;
determining whether the active voice call on the modem stack associated with the second subscription is ongoing; and
realigning the audio data processing for the active voice call on the modem stack associated with the second subscription based on the second packet exchange timeline in response to determining that audio data processing for the active voice calls will conflict in time.
